(19) United States
(12) Patent Application Publication
(10) Pub. No.: US 2018/0276658 A1
(43) Pub. Date: Sep. 27, 2018

(54) PULL AND PUSH SYSTEM FOR X-PAY DIGITAL WALLETS

(71) Applicant: Mastercard International Incorporated, Purchase, NY (US)

(72) Inventors: Maurice David Liscia, Long Island City, NY (US); Shawn Eric Hagmeier, St. Peters, MO (US); Sowmya Reddy Lakka, Wildwood, MO (US); Pablo Fourez, White Plains, NY (US); Gerardo Cardone, Staten Island, NY (US)

(21) Appl. No.: 15/936,890

(22) Filed: Mar. 27, 2018

Related U.S. Application Data
(60) Provisional application No. 62/476,971, filed on Mar. 27, 2017.
(60) Provisional application No. 62/534,734, filed on Jul. 20, 2017.

(51) Int. Cl. G06Q 20/36; G06Q 20/10; G06Q 20/40; G06Q 20/32; G06Q 20/38

(52) U.S. Cl. CPC G06Q 20/3674; G06Q 20/102; G06Q 20/382; G06Q 20/3276; G06Q 20/40

(57) ABSTRACT

Provided are systems and methods for extending QR and person-to-person based digital wallet payments to non-issuer digital wallets. In one example, the method may include receiving a send request to send payment from a sending account of a digital wallet to a receiving account, executing an authentication protocol between the mobile device and an issuer of the sending account, pulling the requested payment from the issuer of the sending account to the sponsor system, where the pulling shifts a liability of a chargeback to the issuer of the sending account, and pushing the requested payment from the sponsor system to an issuer of the receiving account. In addition, if the merchant is a QR merchant, a method may include accessing the PAN and merchant info from the QR code to process a pull/push transaction using non-issuer digital wallet credentials from contactless tap.

### CROSS-REFERENCE TO RELATED APPLICATIONS

This application claims the benefit under 35 USC § 119(e) of previously filed U.S. Provisional Patent Application No. 62/476,971, filed on Mar. 27, 2017, and U.S. Provisional Patent Application No. 62/534,734, filed on Jul. 20, 2017, both of which are incorporated herein by reference in their entireties.

### BACKGROUND

Payment accounts such as debit cards, credit cards, and cash cards are widely used to settle purchase transactions at a point of sale such as a merchant's premises or via an online website or portal. Frequently, the merchant has a point of sale (POS) terminal in place to assist in performing the purchase transaction, including reading of payment account information from a payment card or a payment-enabled mobile device. By reading the payment account information and by subsequent activity performed by the POS terminal, the merchant is said to “accept” the resulting payment account system transaction.

During an initial read/swipe of the payment card/account by an in-store terminal or an online portal, etc., the cardholder's account may be checked to see if enough funds are available to pay for the transaction. If so, the transaction may be approved and the merchant is allowed to authorize the transaction. However, the actual exchange of funds from the cardholder's account to the merchant's account is not performed immediately. Rather, at the end of each business day, the merchant sends approved authorizations in a batch to an acquiring bank or a payment processor. The acquiring bank or the payment processor then routes the batched information to a credit card payment network for clearing and settlement. In response, the credit card payment network forwards each approved transaction to the appropriate issuing bank of the cardholder accounts. Usually within one to two business days of the transaction, the issuing bank will transfer the funds which it shares with the credit card payment network and the acquiring bank credits the merchant's account for cardholder purchases.

However, the clearing and settlement process typically requires one or more business days to be completed. Merchants may not receive funds until the clearing and settlement is fully completed. Furthermore, in some situations, a merchant may wish to accept contactless payment account system transactions without having a contactless payment infrastructure in place. For example, a small merchant may not wish to expend the costs involved in obtaining and installing contactless hardware systems. Also, in some cases when a POS terminal owned by a merchant has reached the end of its useful life, the merchant may wish to continue to accept payment account system transactions through alternative channels without purchasing a replacement for the currently installed POS terminal.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a diagram illustrating a system for performing a pull and push payment process, according to an example embodiment.

FIG. 2 is a diagram illustrating a system for performing a pull and push payment process, according to another example embodiment.

FIG. 3 is a diagram illustrating a process of a sponsor system determining an identity of an issuer, according to an example embodiment.

FIG. 4 is a diagram illustrating an example of an authentication process, according to an example embodiment.

FIG. 5 is a diagram illustrating a local pull and push payment process according to an example embodiment.

FIG. 6 is a diagram illustrating a method of pulling and pushing a payment, according to an example embodiment.

FIG. 7 is a diagram illustrating a computing system that may be used, according to an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Traditional payment processing requires an overnight clearing and settlement process which can take at least one business day or more. In addition, when a payment is transacted on a weekend or a holiday, the payment is not processed until after the next business day resulting in an additional delay before funds are transferred from a cardholder (“consumer”) to a merchant. The example embodiments overcome these deficiencies in the traditional payment clearing and settlement process by making funds available in merchant account in less than an hour (e.g., 10 minutes, 20 minutes, 30 minutes, etc.) without the need for an overnight clearing and settlement. The almost real-time transfer of funds simultaneously effects a transfer in liability. Accordingly, a merchant account can be credited funds in the same day (or even the same hour) making ready access to funds.

As described herein, a sponsor system such as an acquiring bank, an issuing bank, a payment processor, an application programming interface (API), or the like, can communicate with a digital wallet operated by the cardholder and can act on behalf of a cardholder to transfer payment from the cardholder's account to a merchant's account through a pull and a push process. The pull and the push are separate one-way transactions that move money from the issuer of the sending account to the sponsor system and then from the sponsor system to the issuer of the merchant account. For example, a cardholder may select a payment account within the digital wallet and submit a payment request to a sponsor system based on a quick response (QR) code scanning performed to capture a merchant QR code. Embedded within the QR code may be merchant account information and merchant information. In addition to the merchant account information, the cardholder device may also transmit cardholder account information (encrypted) which is stored in the digital wallet. Accordingly, the sponsor system can receive issuing account information of both the cardholder and the merchant.

During the pull process, the sponsor system may pull a payment requested by the cardholder from an issuer of the cardholder account to the sponsor system based on the cardholder PAN received from the digital wallet. During the push process, the sponsor system may push the pulled funds from the sponsor system to the issuer of the merchant account based on the merchant PAN received from the digital wallet. In some cases, both the cardholder PAN and the issuer PAN may be provided during the initial send request from the digital wallet, or the merchant PAN may be provided after the pull process has been performed. Furthermore, prior to performing the pull operation, the issuer of the cardholder account and the cardholder may perform an authentication protocol, via the sponsor system and a payment network, which can transfer liability of a chargeback of the pulled funds from the sponsor system to the issuing bank of the cardholder without requiring an overnight settlement and clearing process. In this way, each of the pull operation and the push operation are essentially one-way transactions and the liability is shifted from the sponsor system to the issuing bank of the sender as the payment is transferred. Furthermore, the funds are made available in the merchant account almost immediately in contrast to traditional payment processing where the funds are not made available until completion of a clearing and settlement process (which usually requires one or more overnight cycles).

In the examples herein, various devices and systems may interact to perform such payment process including, for example, a mobile device having a companion application (e.g., non-issuer digital wallet), a cardholder account (or sending account) issuer system such as a system controlled by a financial institution that issues a payment account included in the third-party wallet, an acquirer (financial institution that sponsors pull/push payment) system, a payment send API (e.g., MasterCard Send API, etc.), a merchant account issuer system, a payment network which may include payment network devices and other systems such as payment gateways, clearing houses, banks, payment processor, and the like.

The systems and methods described herein may be used to settle a transaction for the purchase of items (e.g., goods and services) using a QR code based payment system with a digital wallet. The system allows a fast, secure, convenient and cost-effective method, and provide a viable alternative to cash without the need for point of sale (POS) equipment. Furthermore, the systems and methods may solve many of the pain points surrounding e-payments for merchants and acquiring banks and is a viable way to extend electronic payment services to merchants that are currently excluded from them. Moreover, the systems and methods described herein can effect a pull and push payment to facilitate near real-time fund movement to merchant accounts.

QR payment invocation requires a merchant to register with an acquiring bank (i.e., an acquirer) to receive a QR code. Typically, a consumer cardholder was required to register with a digital wallet of an issuer of their payment card, and download a QR payment application to their mobile device. The merchant can display the QR code (e.g., on a receipt) and the consumer can scan in the code using a camera of their mobile device and optionally enter in the payment amount if it is not already included within the QR code. The consumer then initiates the payment through the QR based digital wallet application on their mobile device. In this case, the digital wallet on the mobile device is controlled and owned by the issuer of the cardholder payment account. Therefore, the issuer has direct access to the cardholder's information such as account balance, authentication information, card details, and the like.

However, related QR code based payments are only available for digital wallets that are backed/controlled by issuer-based financial providers such as banks, credit agencies, and other financial entities having a money transfer license. In particular, even though the funds are transferred from the cardholder's account to the merchant's account in real-time, the transaction between the issuer and the acquirer still must subsequently clear through a payment network (e.g., at the end of the day, at the end of a two day cycle, etc.). Therefore, there is a level of trust that occurs between the issuer (cardholder's bank) and the acquirer (merchant's bank) that the funds will be available at the time of clearing.

To improve upon the related QR payment processing procedure, the example embodiments extend the ability of making QR code based payments to non-issuer digital wallets (also referred to as X-pay wallets) which can hold one or more issuer-based payment cards and/or accounts. As described herein, a non-issuer digital wallet refers to digital wallets that are not owned and operated by financial institutions but instead are controlled by entities that do not hold a money transfer license. Because every state has its own licensing requirements, there is variability in money transmitter requirements from state-to-state. However, almost every state requires transmitters to satisfy requirements to be licensed as a money transmitter such as securing a surety bond, as well as federal registration requirements with the Financial Crimes Enforcement Network (FinCEN). In addition, money transmitters must be licensed in every state in which transmission activity takes place. Therefore, money transfer licenses can be a significant expense of time and money.

Non-issuer digital wallets do not need money transfer licenses because they do not manage money transfer. There are dozens of non-issuer based digital wallets including original equipment manufacturer (OEM) based wallets such as Samsung Pay, Apple Pay, Android Pay, etc., as well as other non-issuer wallets such as MasterPass by Mastercard, Google Wallet, Oracle Pay, etc. Up until know, these non-issuer digital wallets were unable to participate in QR based pull and push transactions. The example embodiments now enable such non-issuer digital wallets to send money immediately from a cardholder to a merchant.

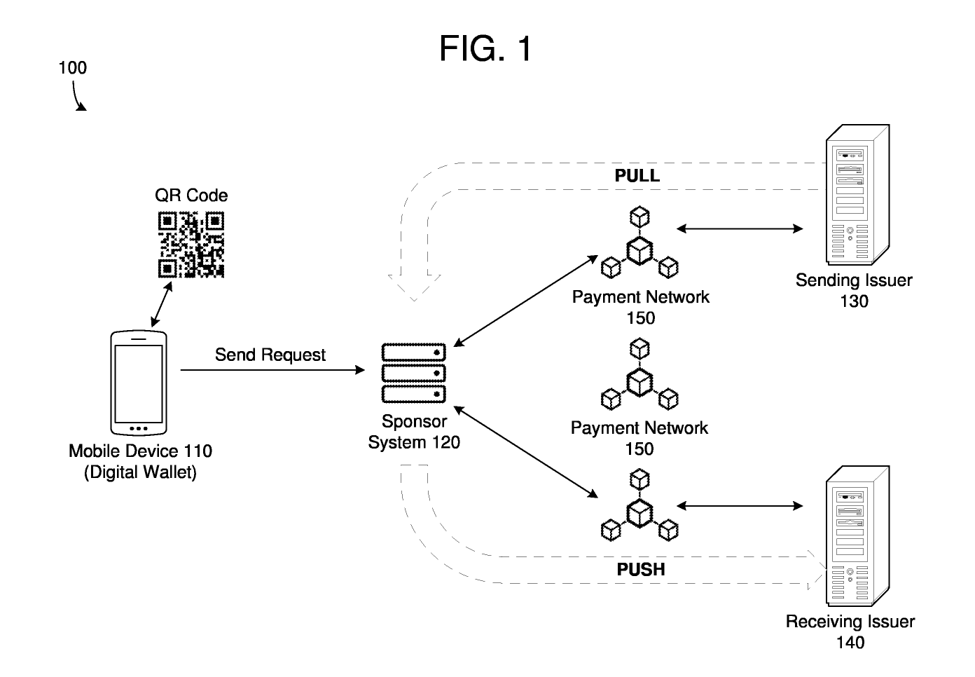

FIG. 1 illustrates a system 100 for performing a pull and push payment process, according to an example embodiment. Referring to FIG. 1, the system 100 includes a mobile device 110 implementing a digital wallet such as a non-issuer digital wallet, but embodiments are not limited to a non-issuer digital wallet and may include an issuer-based digital wallet. The mobile device 110 may be a smartphone, a tablet, a laptop, a notepad, an appliance, a smart-wearable device or the like, which may be a cardholder or account holder device executing one or more digital wallets. The digital wallet allows the cardholder/user to add payment accounts through a digitization process which can securely store tokenized account information of the payment account on a secure element of the mobile device 110. According to various embodiments, the cardholder (sender) may send money to a receiving account (receiver) such as a merchant account.

The system 100 further includes a sponsor system 120 which can act on behalf of the cardholder of the mobile device 110 to perform a pull and push payment process via a payment network 150 to pull money from a sending account and push the money to a receiving account. The sponsor system 120 may communicate with an issuing bank of the sending account (sending issuer 130) and an issuing bank of a receiving account (receiving issuer 140) via the payment network 150. In one example, the sponsor system 120 may include a computing device/server implementing a send API according to various embodiments. The send API includes services, libraries, code, and the like, which enable the sponsor system 120 to communicate with a payment network and transmit pull and push payment messages. For example, the send API enables the sponsor system 120 to pull a payment from the sending issuer 130 based on a request from a digital wallet on the mobile device 110, and push the pulled payment from the sponsor system 120 to the receiving issuer 140 where the receiving issuer makes funds available in near real time to receiver without requiring an overnight settlement and clearing process to be completed to post funds.

As another example, the sponsor system 120 may include a computing device/server that is controlled by an acquiring bank or other entity that is pre-configured and authorized to conduct send payment transactions without the need for installing the send API. In this example, the sponsor system 120 may be an entity that is unrelated to the cardholder or the merchant involved in the transaction. As another example, the sponsor system 120 may be an issuer of the cardholder account or an issuer of the merchant receiving account. As another example, the sponsor system 120 may be a device including the send API that receives a request from an acquiring bank. In this example, the digital wallet may connect to the acquiring bank, and the acquiring bank may connect to the send API to perform the pull/push payment process.

In either of the API solution and the acquiring bank solution, sponsor system 120 receives both a consumer PAN and a merchant PAN from a point of entry which in the example of FIG. 1 is a non-issuer digital wallet. For example, a consumer may scan a merchant QR code using their non-issuer digital wallet which can parse account information of the merchant from the QR code, and also stores the issuing information of the consumer PAN, and provides those to the sponsor system 120. Here, the QR code may be parsed by the non-issuer digital wallet to obtain the merchant PAN. Meanwhile, the digital wallet may already have stored therein a copy of the consumer's PAN which may be tokenized for purposes of security.

To invoke the pull and push payment process, the mobile device 110 may scan a QR code of a merchant using the non-issuer digital wallet. For example, the QR code may be related to a purchase for an item such as a good, a service, and/or the like. The QR code may include information about the merchant encoded therein such as a merchant account number (PAN), a transaction amount, a merchant category code (MCC), a transaction currency code, a merchant country, merchant city, merchant name, optical data fields, CRC checks, and the like. It should be appreciated that additional information not specifically discussed may also be incorporated within the QR code. To display the QR code, the QR code may be displayed on a screen of a computing device or other object (kiosk, television, POS terminal, etc.) at a merchant location. As another example, the QR code may be included in a receipt for goods or services printed by the merchant or displayed online via web page such that it can be scanned by the cardholder's mobile device 110 at a location that is remote from the merchant.

In response to scanning the QR code, the non-issuer digital wallet may parse the QR data to obtain merchant information such as the merchant PAN encoded in the QR. In addition, the non-issuer digital wallet transmits a pull payment request to the sponsor system 120. Here, the request may be a non-payment message request or it may include a message that is already in a format for processing via a payment network (ISO 8583). If not in a format ready for payment processing, the request may be converted by the sponsor system 120 into an authorization request message that is formatted for the payment network authorization request message. The request sent from the digital wallet on the mobile device 110 to the sponsor system 120 may include one or more values within transaction fields that indicate the request is to be processed as a pull/push payment process.

In response to receiving the request, the sponsor system 120 may secure the payment funds from the cardholder's issuing bank (sending issuer 130) which is the issuer of the sending account. For example, the digital wallet (or wallet provider) may send a QR code scanning request to the sponsor system 120 which then tries to pull money from consumer's issuing bank via the payment network 150. The sponsor system 120 may perform the pull operation by transmitting an authorization request message (e.g., ISO 8583) to the sending issuer 130 via the payment network 150, and receive an authorization response message from the sending issuer 130 via the payment network 150.

Furthermore, before, during, and/or after the pull operation, the mobile device 110 and the sending issuer 130 may perform an authentication process via the sponsor system 120 and the payment network 150 to verify that the cardholder/account is the authorized user and/or card. The authentication process may shift liability of a chargeback from the sponsor system 120 (and the X-pay wallet on the mobile device 110) to sending issuer 130 as a result of the pull transfer. In contrast, for a regular PAN based purchase request, the liability does not shift until a next business day clearing and settlement process has been satisfied.

Once the payment has been pulled from the sending account issued by the sending issuer 130 and transferred to the sponsor system 120, the sponsor system 120 may push the pulled payment to the receiving issuer 140 via the payment network 150. The receiving issuer 140 is the issuer of the receiving account (such as a merchant account). Because of the authentication process that is performed during the pull transaction, the liability of a chargeback shifts from the sponsor system 120 to issuer of the sending account 130 the cardholder. The pull and the push process is essentially a serial two step process where each step includes a one-way payment transfer that is typically performed with an overnight clearing process. However, the pull and push payment process makes the funds available in the receivers account as soon as the receiving issuer 140 approves the push authorization. In other words, the funds are moved from the sending issuer 130 to the receiving issuer 140 in a matter of minutes via the sponsor system 120, and the funds are made available almost in real-time (e.g., 30 minutes, etc.) to the merchant account at the sending issuer 140. The system 100 enables QR payments from a 3rd party wallet provider that is not an issuer of a financial account and does not have a money transfer license. In one embodiment, the sponsor system 120 may be an acquiring a bank that processes the pull/push transaction on behalf of the non-issuer digital wallet. As another example, the sponsor system 120 may be a device implementing a send API (e.g., MasterCard Send API, etc.) which performs the pull/push transaction process on behalf of the non-issuer digital wallet. The difference with traditional send payment systems is that two transactions must happen to effect a pull and a push. A consumer having an account wants to make a payment with that account to a merchant. Money needs to get out of the consumer account and pushed to the merchant account. When the consumer is using an issuer-based digital wallet, the issuer has direct access to cardholder account information. Therefore, the issuer can get money directly out of the account without having to worry to process a pull request. However, in the context of a non-issuer digital wallet, the consumer provides a PAN (which may be a token) but the non-issuer digital wallet does not have the ability to transfer money out of the consumer's account. The pull and push process performed by the sponsor system 120 on behalf of the non-issuer digital wallet on the mobile device 110 brings the solution to life.

It should also be appreciated that the example embodiments are not limited to a request being triggered by a non-issuer digital wallet. As another example, rather than receive a request from a digital wallet, the pull/push process may be leveraged by a financial institution such as an acquiring bank, an issuing bank, and the like. Therefore, it should be appreciated that the example of FIG. 1 is not limited to being performed in response to a request from a non-issuer digital wallet.

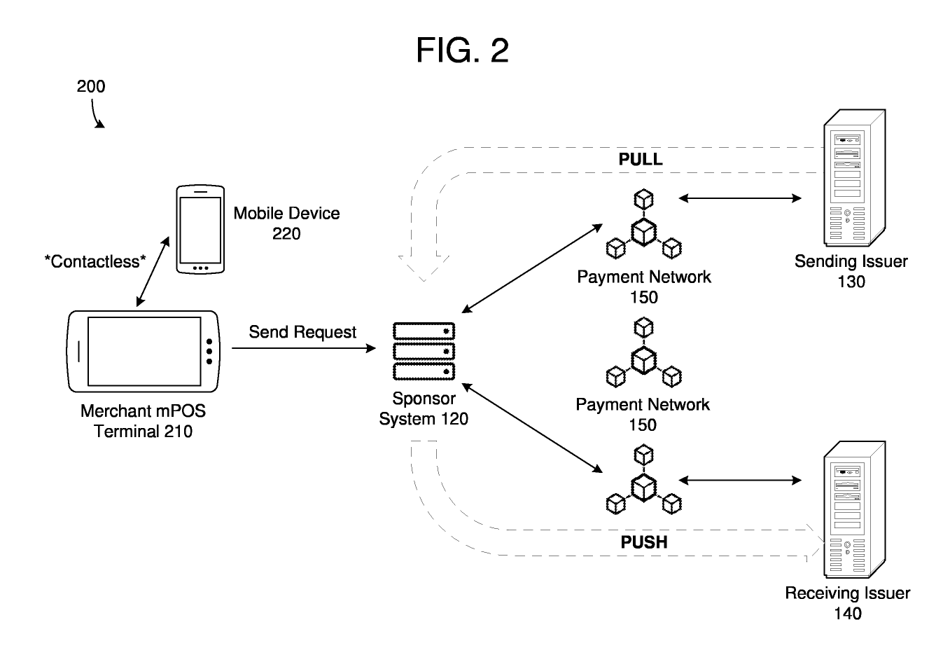

FIG. 2 illustrates an example a system 200 for performing a pull and a push payment process, in accordance with another example embodiment. In the example of FIG. 2, the pull and push network is the same as in FIG. 1, but the point of entry is a merchant's mobile point-of-sale (mPOS) terminal 210 which receives the consumer's PAN and stores the merchant's issuer PAN, which are then provided to the sponsor system 120. In this example, the mPOS terminal 210 may receive a contactless payment transaction from a digital wallet on a mobile device 220 without requiring the merchant to install contactless payment equipment and infrastructure. For example, a contactless payment may be performed between a cardholder (sender) and a merchant (receiver) where the payment credentials are transferred to the merchant mPOS terminal 210 from the mobile device 220 via a wireless protocol. When the cardholder brings the mobile device 220 (or other payment vehicle such as emitting card, etc.) within a proximity or a predetermined distance of a merchant mPOS terminal 210, payment account information may be transferred wirelessly from the mobile device 220 to the mPOS terminal 210.

For example, contactless payment systems include credit cards and debit cards, key fobs, smart cards or other devices, including smartphones and other mobile devices, that use radio-frequency identification (RFID) or near field communication (NFC) such as Apple Pay®, Samsung Pay®, Google Wallet®, and the like, for making secure payments. The embedded chip and antenna enable consumers to wave or otherwise swipe their card, fob, or handheld device over a reader at the mPOS terminal 210. Contactless payments are made in close physical proximity, unlike mobile payments which use broad-area cellular or Wi-Fi networks and do not usually involve close physical proximity.

Typically, supporting contactless payments requires significant infrastructure by an acquiring bank of a merchant in order to adhere to requirements for handling contactless payment account transactions. As a result, the acquirer must add overhead to payment information received from the merchant and also take certain precautions with sensitive financial account information stored therein to prevent fraud or leak of the sensitive data. However, the example embodiments improve upon this requirement by enabling contactless payments without requiring an acquiring bank. In the example of FIG. 2, a non-issuer digital wallet on mobile device 220 may transfer contactless transaction details of a payment account of the cardholder to the merchant mPOS terminal 210 via a contactless payment method to settle a transaction between the cardholder and the merchant. The contactless transaction details may include a PAN, an expiration date, a CVC, a name, an address, and the like, of a payment account associated with the cardholder, merchant information, transaction information, and the like.

The sponsor system 120 may be a payment processor implementing the send API. Therefore, rather than require the infrastructure of an acquiring institution between the merchant mPOS terminal 210 and the payment network 150, the sending issuer 130, and the receiving issuer 140, the system 200 may omit an acquirer. As a result, the system 200 does not need to support an infrastructure of the acquirer, moreover, the merchant mPOS terminal 210 can communicate directly with a payment processor (sponsor system 120) which may be implementing the send API. Furthermore, the process may rely on devices already established within a payment network thereby making the payment processing of the contactless payment transaction significantly faster.

The API implemented by the sponsor system 120 in FIGS. 1 and 2, may package transaction details (e.g., non-issuer digital wallet, contactless transaction details, etc.) into an appropriate message (e.g., authorization request/response) through a payment processor send API such as MasterCard Send Unified API. The API may accept merchant details and process a non-issuer pull push transaction (FIG. 1) and a contactless funding transaction (FIG. 2) between a consumer issuer 130 and a merchant issuer 140. Furthermore, the API may also facilitate clearing and settlement for the transaction with the consumer issuer 130 and the merchant issuer 140.

This solution allows merchants to process payments in multiple forms. For example, in one form, as a regular contactless pull transaction leveraging a system where the merchant receives the funds as part of the standard clearing and settlement process. Alternatively, if the merchant is also a QR merchant they can access their merchant PAN from QR along with other merchant info and provide consumer payment data to process a pull and push transaction with an API which will allow the merchant to receive funds in a near real time and without requiring a standard clearing and settlement process.

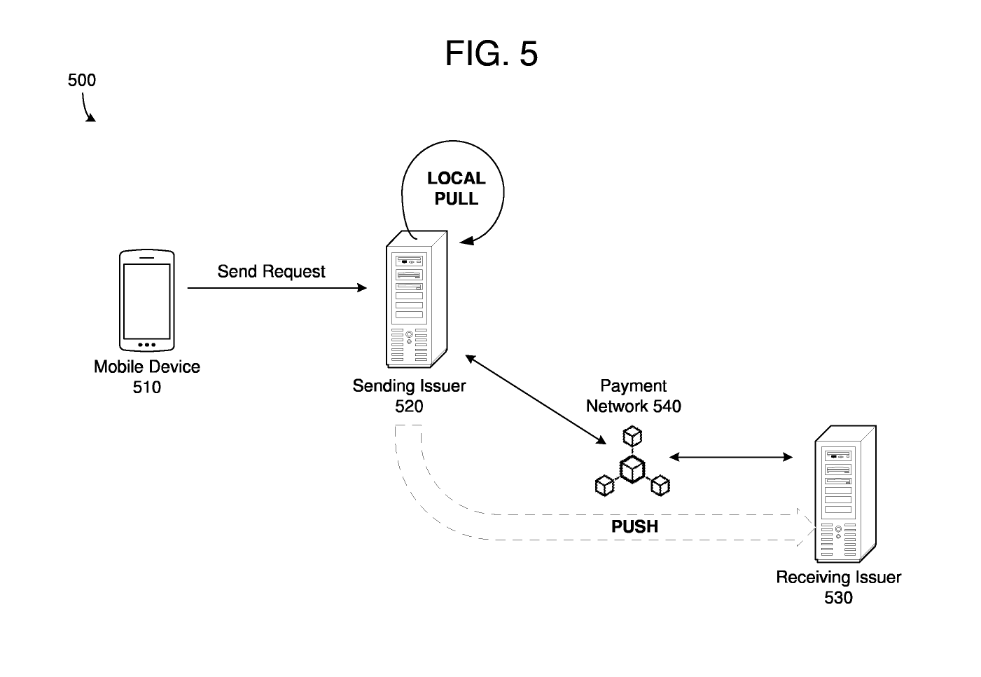

Some of the benefits of removing the acquirer include allowing the merchant to access QR payments. Furthermore, the merchant can leverage the same existing core data system and be in a position to perform a contactless transaction without the need for an acquirer. All the entities that a merchant needs to process a payment need to accommodate a set of requirements for contactless payments. These requirements are no longer required for an acquirer infrastructure because the merchant back office is directly integrating into the payment processor API. Another extended benefit is that the local pull and push process described with respect to FIG. 5 makes funds available in a merchant account almost immediately rather than after a traditional settlement process which clears only once a business day (24 hours) or longer.

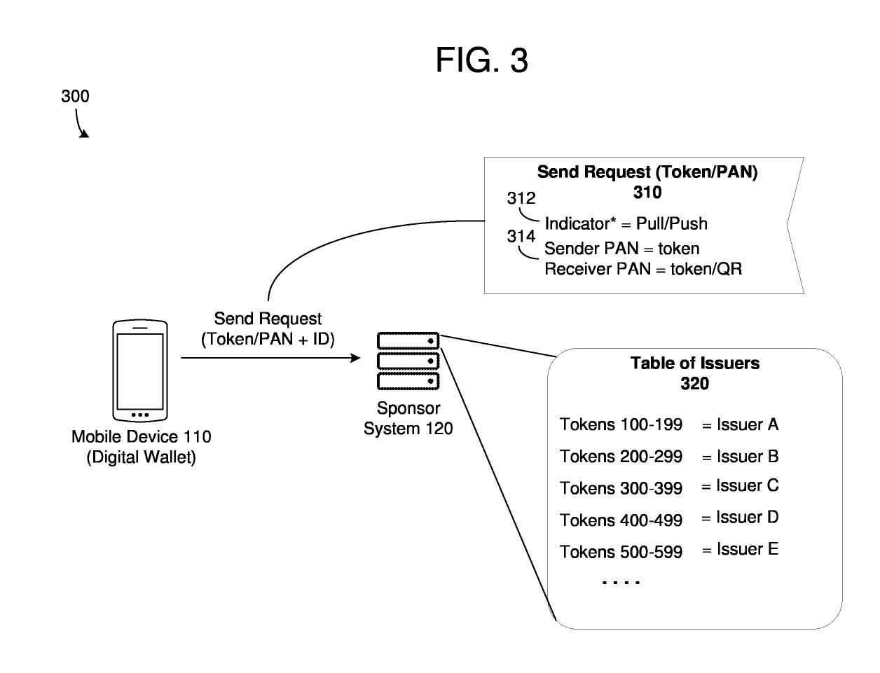

FIG. 3 illustrates a process 300 of a sponsor system 120 determining an identity of an issuer, according to an example embodiment. Referring to FIG. 3, a send request 310 is transmitted from a digital wallet executing on a mobile device 110 to a sponsor system 120. The send request may be a message request including an identifier or an indicator that the mobile device 110 desires to initiate a pull/push transaction along with secure sending account and receiving account information. The send request 310 may also include tokenized data of the cardholder primary account number (PAN) which can be compared to a table of issuers 320 to determine which issuer is the owner of the token. Here, each issuer is assigned a range of token values in the table 320.

In some embodiments, the send request 310 may not be an authorization message capable of payment network transmission. In this example, when the send request is not in a payment network format, the sponsor system 120 may convert the payment information into an authorization message (ISO 8583) and insert a value into one or more fields of the authorization message indicating that the message is a pull or a push request depending on which operation the sponsor system 120 is performing. As a non-limiting example, the indicator may include a text value, a bit value, a numerical value, a symbol, or the like, which is included within a transaction field of the payment authorization request that constitutes the send request.

For example, a processing code value of ‘00’ along with a specific merchant category code (MCC) value may determine that the transaction is a pull transaction. For example, for a pull transaction, a DE3 value from the message may be ‘00,’ a DE18 value may be 6538 for person to person, or the actual merchant MCC for person to merchant payment, and a DE48SE77 value may have a value of ‘C07’ for person to person and ‘C67’ for person to merchant. Similarly, for a push transaction, the DE3 and DE48SE77 values may be the same as the pull transaction, while the DE18 value may be 6536 for domestic, 6537 for cross border, and the actual merchant MCC for person to merchant payment. The authorization message may be transmitted to the issuer of the sending account or the issuer of the receiving account depending on whether the pull or the push is being performed.

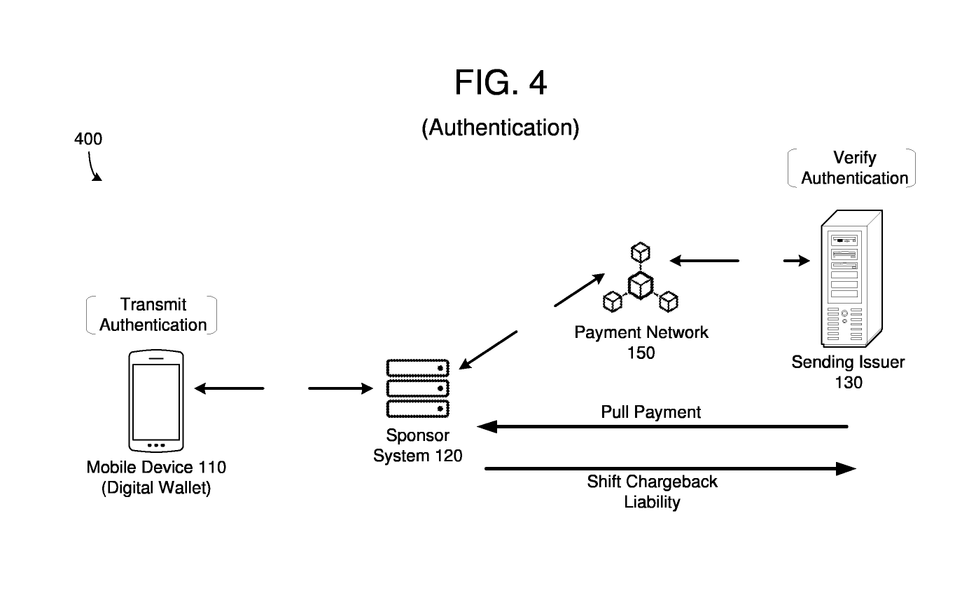

FIG. 4 illustrates an example of an authentication process 400, according to an example embodiment. Referring to FIG. 4, the authentication process 400 is performed between a digital wallet executing on a mobile device 110 and an issuer 130 of a payment account included in the digital wallet. Here, the authentication process 400 is performed via the sponsor system 120 and the payment network 150. The authentication processor 400 may be a digital secure remote payment (DSRP) authentication process which authenticates EMV information stored on the mobile device 110 via EMV protocol. The authentication process 400 can be performed before a pull/push payment request, during a pull/push payment request, and the like.

The DSRP authentication implements tokenization and dynamic cryptograms to online shopping in order to achieve the same level of transaction security as held through a contactless transaction in-store. The authentication process 400 may utilize the mobile device 110 capabilities and may include functions such as authentication, token retrieval, and cryptogram generation. Facilitating this requires the wallet application on the mobile device 110 and the issuer 130 to communicate, and both parties may implement the relevant APIs and SDKs to perform DSRP.

All DSRP transactions go through the mobile device 110 in order to retrieve the tokens, in addition to the consumer who is required to apply their mobile PIN for payment authentication (e.g., via a user interface of the mobile device 110). Successful authentication leads to the sending of the token and generated cryptograms from the device to the online merchant, who will process these as a substitute for card-on-file data. The authentication process 400 shifts a chargeback liability of the pulled payment from the sponsor system 120 to the sending issuer 130 of the payment account included in the mobile wallet 110. For example, during a pull transaction, a liability shift may be obtained by utilizing device-based DSRP. At least one of a payment network device, an issuer system, a digital wallet executing on the user device, and the like, may indicate that the authentication has been performed and that liability has been shifted through DSRP by inserting a security level indicator (e.g., 242, 247, etc.) in an ISO 8583 authorization/clearing message. In some examples, issuer systems, payment processing systems, or the like, may delegate the authentication of the cardholder to the device wallet through an ID and verification (ID&V) process at a time of tokenization.

It should also be appreciated that the authentication process 400 is not limited to DSRP, but may include secure code for verifying a PAN, and the like. For example, during a pull transaction, a liability shift may be obtained by utilizing a three-dimensional (3D) secure code which is a technical standard for securing cardholder not present transactions. At least one of a payment network device, an issuer system, a digital wallet executing on the user device, and the like, may indicate that the authentication has been performed and that liability has been shifted through 3D secure by inserting a security level indicator (e.g., 212, etc.) in an ISO 8583 authorization/clearing message. In some examples, issuer systems can authenticate a cardholder through a step up or by leveraging the data provided in the authentication request (risk based authentication). For example, 3D secure may enable an issuer access control server (or ACS) to receive the data and initiate a cardholder step up if necessary.

FIG. 5 illustrates a local pull and push payment process 500 performed by a sponsor node 520 according to an example embodiment. In this example, the sponsor node 520 is also an issuer of the sending account being used by the non-issuer digital wallet executing on the mobile device 510. Here, the sponsor node 520 performs a self-acquiring local pull operation without having to transmit and receive authorization for the sending account via a payment network to a separate issuing system. In this example, the sponsor node 520 performs the role of both acquirer and issuer in the pull process.

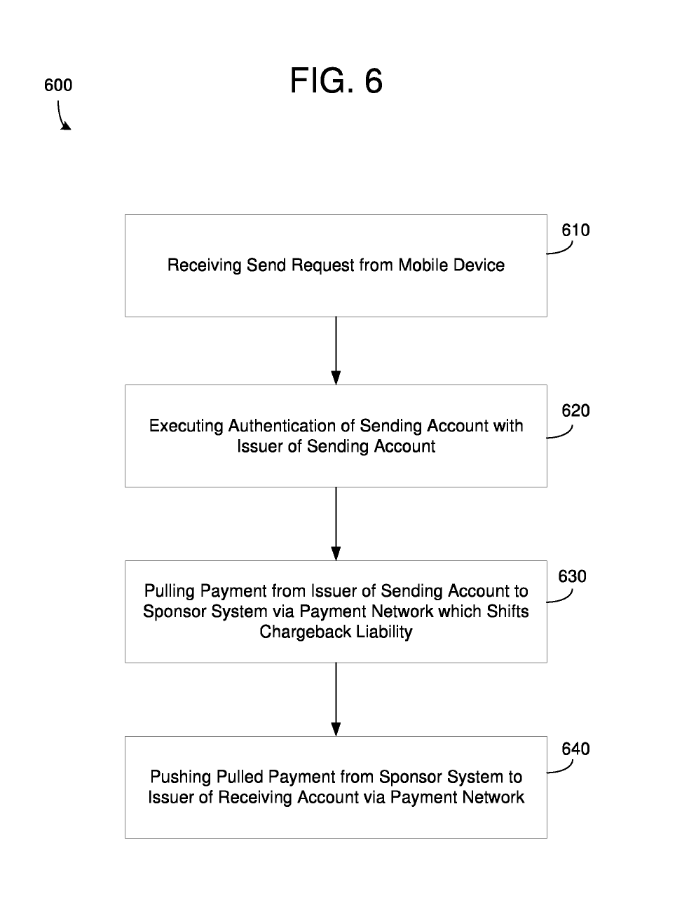

FIG. 6 illustrates a method 600 of pulling and pushing a payment, according to an example embodiment. For example, the method 600 may be performed by a sponsor system such as a computing system of a financial institution (acquiring bank), a payment processing device executing a send API, and the like. Referring to FIG. 6, in 610, the method includes receiving a send request for transferring money from a sending account to a receiving account. In one example, the send request may be received from a digital wallet (e.g., non-issuer digital wallet) executing on a mobile device based on a QR code scanning operation performed via the mobile device. As another example, the send request may be received from a mPOS terminal which receives a contactless touch from a mobile device of a sending account. In either case, the send request may include a PAN of the sending account and a PAN of the receiving account.

In addition, the send request may be converted into an authorization message that includes an indicator within a field of the request (e.g., authorization request) that indicates that the send request is a pull/push payment request. As a non-limiting example, the indicator may include a text value, a bit value, a numerical value, a symbol, or the like, which is included within a transaction field of the payment authorization request that constitutes the send request. For example, a processing code value of ‘00’ along with a specific merchant category code (MCC) value may determine that the transaction is a pull transaction. For example, for a pull transaction, a DE3 value from the message may be ‘00,’ a DE18 value may be 6538 for person to person, or the actual merchant MCC for person to merchant payment, and a DE48SE77 value may have a value of ‘C07’ for person to person and ‘C67’ for person to merchant. Similarly, for a push transaction, the DE3 and DE48SE77 values may be the same as the pull transaction, while the DE18 value may be 6536 for domestic, 6537 for cross border, and the actual merchant MCC for person to merchant payment.

In 620, the method may include executing, via the sponsor system, an authentication protocol between the mobile device and an issuer of the sending account. For example, when the send request is received from a non-issuer digital wallet, the authentication may be performed between the digital wallet on the mobile device and the issuer of the sending account to verify at least one of a cardholder identity (e.g., via a PIN or secure code for PAN), or to verify the payment account (e.g., digital secure remote payment, etc.) For example, the send request may be received from a non-issuer digital wallet (e.g., OEM wallet, etc.) that does not have authorization to access account information of the sending account stored by the issuer of the sending account. By authenticating one of the card and the user, the account and/or the cardholder can be verified even though the digital wallet is not controlled by a financial institution and does not communicate directly with the issuing bank or a payment network.

In 630, the method includes pulling the requested payment from the issuer of the sending account to the sponsor system via a payment network based on issuer information of the sending account included in the send request, and in 640, pushing the requested payment from the sponsor system to an issuer of the receiving account via the payment network based on issuer information of the receiving account included in the request. Each of the pulling and the pushing may include an exchange of authorization requests/responses that may be generated by the sponsor system based on data received from the mobile device/cardholder. As an example, the pulling may include transmitting an authorization request for the payment from the sponsor system to the sending account issuer system, and receiving an authorization response including the payment authorization. As another example, the pushing may include transmitting an authorization request for pushing the payment to the issuer of the receiving account, and an authorization response from the issuer of the receiving account indicating the push is authorized.

In some embodiments, the sponsor system may determine the issuer of the sending account based on a token range that includes a token ID received from the cardholder digital wallet from among a plurality of token ranges paired with respective issuer IDs. Here, the token ID may represent tokenized cardholder payment information (e.g., PAN, expiry, CVC, etc.) In addition, because of the authentication performed in 620, the pulling of the payment via the payment network shifts a liability of a chargeback of the pulled payment from the sponsor system to the issuer of the sending account in response to a successful authentication protocol being executed.

In some embodiments, the pulling of the requested payment and the pushing of the requested payment are performed by an application programming interface (API) executing on the sponsor system. The API may implement services and interfaces that enable the sponsor system to communicate with the issuer of the sending account and an issuer of the merchant account, via a payment network, on behalf of the cardholder or account holder of the sending account. In some embodiments, the pulling the requested payment and pushing the requested payment are performed by the sponsor system without requiring an overnight settlement process to settle the pulling and the pushing of the payment from the issuer of the sending account to the issuer of the receiving account.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

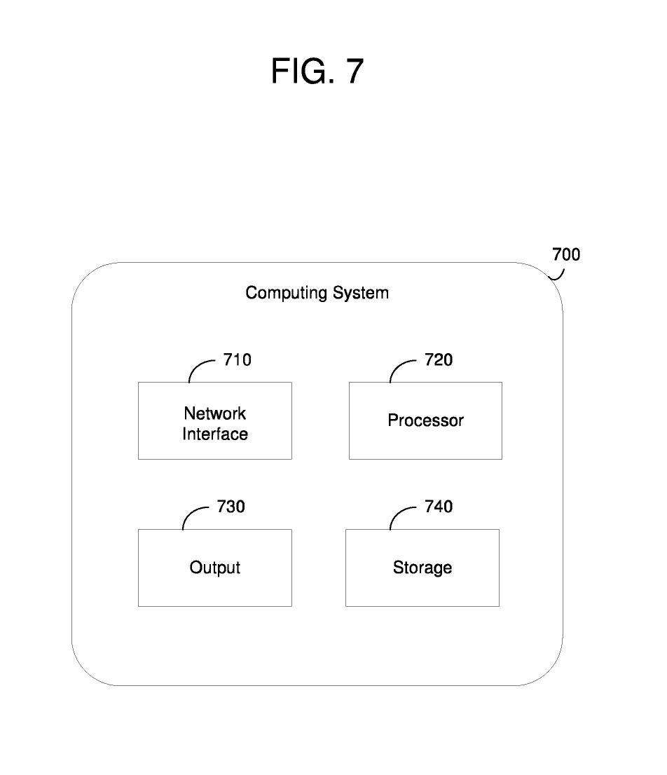

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 7 illustrates an example computer system architecture which may represent or be integrated in any of the above-described components, etc. FIG. 7 is not intended to suggest any limitation as to the scope of use or functionality of embodiments of the application described herein. The computing system 700 is capable of being implemented and/or performing any of the functionality set forth hereinabove.

The computing system 700 may include a computer system/server, which is operational with numerous other general purpose or special purpose computing system environments or configurations. Examples of well-known computing systems, environments, and/or configurations that may be suitable for use as computing system 700 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, and the like, which may include any of the above systems or devices, and the like.

The computing system 700 may be described in the general context of computer system-executable instructions, such as program modules, being executed by a computer system. Generally, program modules may include routines, programs, objects, components, logic, data structures, and so on that perform particular tasks or implement particular abstract data types. The computing system 700 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computing system 700 is shown in the form of a general-purpose computing device. The components of computing system 700 may include, but are not limited to, a network interface 710, one or more processors or processing units 720, an output 730 which may include a port, an interface, etc., or other hardware, for outputting a data signal to another device such as a display, a printer, etc., and a storage device 740 which may include a system memory, or the like. Although not shown, the computing system 700 may also include a system bus that couples various system components including system memory to the processor 720.

The storage 740 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random access memory (RAM) and/or cache memory. As another example, storage device 740 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 740 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 700 may also communicate with one or more external devices such as a keyboard, a pointing device, a display, etc.; one or more devices that enable a user to interact with computer system/server; and/or any devices (e.g., network card, modem, etc.) that enable computing system 700 to communicate with one or more other computing devices. Such communication can occur via I/O interfaces. Still yet, computing system 700 can communicate with one or more networks such as a local area network (LAN), a general wide area network (WAN), and/or a public network (e.g., the Internet) via network interface 710. As depicted, network interface 710 may also include a network adapter that communicates with the other components of computing system 700 via a bus. Although not shown, other hardware and/or software components could be used in conjunction with the computing system 700. Examples include, but are not limited to: microcode, device drivers, redundant processing units, external disk drive arrays, RAID systems, tape drives, and data archival storage systems, etc.

Referring to FIG. 7, the network interface 710 may receive, from a digital wallet executing on a mobile device, a send request to send payment from a sending account included in the digital wallet to a receiving account. In this example, the processor 720 may execute an authentication protocol between the mobile device and an issuer of the sending account. As another example, the network interface 710 may receive, from a merchant's mobile point-of-sale (mPOS) system executing on a mobile device, a send request to send payment from a sending account to a receiving account associated with the mPOS.

In either case, the processor 720 may control the network interface 710 to pull the requested payment from the issuer of the sending account to the sponsor system via a payment network based on issuer information of the sending account included in the send request. Here, the pulling of the payment via the payment network may shift a liability of a chargeback of the pulled payment from the issuer of the sending account to the sponsor system in response to a successful authentication protocol being executed. In addition, the processor 720 may control the network interface 710 to push the requested payment from the sponsor system to an issuer of the receiving account via the payment network based on issuer information of the receiving account included in the request.

It will be readily understood that descriptions and examples herein, as generally described and illustrated in the figures, may be arranged and designed in a wide variety of different configurations. Thus, the detailed description of the embodiments is not intended to limit the scope of the application as claimed, but is merely representative of selected embodiments of the application. One of ordinary skill in the art will readily understand that the above may be practiced with steps in a different order, and/or with hardware elements in configurations that are different than those which are disclosed. Therefore, although the application has been described based upon some preferred embodiments, it would be apparent to those of skill in the art that certain modifications, variations, and alternative constructions would be apparent.

What is claimed is:

1. A sponsor system performing push-pull payments, comprising:
a network interface configured to receive, from a digital wallet executing on a mobile device, a send request to send payment from a sending account included in the digital wallet to a receiving account; and
a processor configured to
execute an authentication protocol between the mobile device and an issuer of the sending account,
control the network interface to pull the requested payment from the issuer of the sending account to the sponsor system via a payment network based on issuer information of the sending account included in the send request, where pulling of the payment via the payment network shifts a liability of a chargeback of the pulled payment from the sponsor system to the issuer of the sending account in response to a successful authentication protocol being executed, and
control the network interface to push the requested payment from the sponsor system to an issuer of the receiving account via the payment network based on issuer information of the receiving account included in the request.

2. The sponsor system of claim 1, wherein the processor performs the pulling of the requested payment and the pushing of the requested payment based on an application programming interface (API) executing on the sponsor system.

3. The sponsor system of claim 1, wherein the processor is configured to perform the pulling of the requested payment and the pushing of the requested payment without requiring an overnight settlement process to settle the pulling and the pushing of the payment from the issuer of the sending account to the issuer of the receiving account.

4. The sponsor system of claim 1, wherein the processor controlling the network interface to pull the requested payment from the issuer comprises controlling the network interface to transmit an authorization request to a processing device of the issuer of the sending account requesting the requested payment, and receive an authorization response generated by the processing device of the issuer of the sending account transferring the requested payment.

5. The sponsor system of claim 1, wherein the send request comprises a quick response (QR) code scan request for sending money from a cardholder account of the digital wallet to a merchant account associated with the QR code without requiring an overnight settlement process to settle the pulling and the pushing of the payment from the issuer of the cardholder account to the issuer of the merchant account.

6. The sponsor system of claim 1, wherein the send request is received from a non-issuer digital wallet that does not have authorization to access account information of the sending account stored by the issuer of the sending account.

7. The sponsor system of claim 1, wherein the send request is received from an original equipment manufacturer (OEM) wallet that does not have authorization to access account information of the sending account stored by the issuer of the sending account.

8. The sponsor of claim 1, wherein the authentication protocol executed by the processor comprises at least one of a digital secure remote payment (DSRP) process to authenticate a primary account number (PAN) of the sending account, and transmission of a secure code between the digital wallet and the issuer of the sending account to authenticate a user of the digital wallet.

9. A sponsor system performing push-pull payments, comprising:
a network interface configured to receive, from a mobile point-of-sale (mPOS) system executing on a mobile device, a send request to send payment from a sending account to a receiving account associated with the mPOS; and
a processor configured to
process the send request via an application programming interface (API) of the sponsor system, wherein, via the API, the processor is configured to pull the requested payment from the issuer of the sending account to the sponsor system via a payment network based on issuer information of the sending account included in the send request, and pulling of the payment via the payment network shifts a liability of a chargeback of the pulled payment from the sponsor system to the issuer of the sending account in response to a successful authentication protocol being executed, and
push the requested payment from the sponsor system to an issuer of the receiving account via the payment network based on issuer information of the receiving account included in the request.

10. The sponsor system of claim 9, wherein the send request is triggered by a contactless payment between a digital wallet including the sending account and the mPOS executing on the mobile device.

11. The sponsor system of claim 9, wherein the pulling the requested payment and the pushing the pushing the requested payment are performed by the sponsor system without requiring an overnight settlement process to settle the pulling and the pushing of the payment from the issuer of the sending account to the issuer of the receiving account.

12. The sponsor system of claim 9, wherein the API enables the mPOS to accept contactless payments through the mobile device and process the contactless payments on behalf of the mPOS.

13. A method of performing push-pull payments, comprising:
receiving, at a sponsor system from a digital wallet executing on a mobile device, a send request to send payment from a sending account of the digital wallet to a receiving account;
executing, via the sponsor system, an authentication protocol between the mobile device and an issuer of the sending account;
pulling the requested payment from the issuer of the sending account to the sponsor system via a payment network based on issuer information of the sending account included in the send request, wherein the pulling via the payment network shifts a liability of a chargeback of the pulled payment from the sponsor system to the issuer of the sending account in response to a successful authentication protocol being executed; and
pushing the requested payment from the sponsor system to an issuer of the receiving account via the payment network based on issuer information of the receiving account included in the request.

14. The method of claim 13, wherein the pulling the requested payment and the pushing the requested payment are performed by an application programming interface (API) executing on the sponsor system.

15. The method of claim 13, wherein the pulling the requested payment and the pushing the requested payment are performed by the sponsor system without requiring an overnight settlement process to settle the pulling and the pushing of the payment from the issuer of the sending account to the issuer of the receiving account.

16. The method of claim 13, wherein the pulling comprises a processor of the sponsor system controlling a network interface of the sponsor system to transmit an authorization request to a processing device of the issuer of the sending account requesting the requested payment, and receiving an authorization response from the processing device of the issuer of the sending account transferring the requested payment.

17. The method of claim 13, wherein the send request comprises a quick response (QR) code scan request for sending money from a cardholder account of the digital wallet to a merchant account associated with the QR code without requiring an overnight settlement process to settle the pulling and the pushing of the payment from the issuer of the cardholder account to the issuer of the merchant account.

18. The method of claim 13, wherein the send request is received from a non-issuer digital wallet that does not have authorization to access account information of the sending account stored by the issuer of the sending account.

19. The method of claim 13, wherein the send request is received from an original equipment manufacturer (OEM) wallet that does not have authorization to access account information of the sending account stored by the issuer of the sending account.

20. The method of claim 13, wherein the authentication protocol comprises at least one of a digital secure remote payment (DSRP) process to authenticate a primary account number (PAN) of the sending account, and transmission of a secure code between the digital wallet and the issuer of the sending account to authenticate a user of the digital wallet.
